(19) United States
(12) Patent Application Publication
(10) Pub. No.: US 2009/0098964 A1
(43) Pub. Date: Apr. 16, 2009

(54) TRANSMISSION OF BICYCLE

(76) Inventor: Gichun Kim, Seoul (KR)

Correspondence Address: IPLA P.A., 3580 WILSHIRE BLVD., 17TH FLOOR, LOS ANGELES, CA, 90010, US

(21) Appl. No.: 12/298,282

(22) PCT Filed: May 28, 2007
(86) PCT No.: PCT/KR07/02564

§ 371 Date: Oct. 23, 2008

(30) Foreign Application Priority Data
May 29, 2006 (KR) 10-2006-0047916
May 22, 2007 (KR) 10-2007-0049566

(51) Int. Cl. B62M 9/12; F16H 59/04

(52) U.S. Cl. 474/81

(57) ABSTRACT

The present invention relates to a transmission of a bicycle comprising 2 or more front and rear sprockets, a chain transmitting power between the front sprockets and the rear sprockets, front and rear gearing devices for moving the chain left and right, a centrifugal device rotating with the rear sprockets, and a control cable connecting between the rear gearing device and the centrifugal device.

### TECHNICAL FIELD

The present invention regards to transmission method of power. In the concrete the present invention regards to transmission changing rotation speed between principal axis and accompanying axis. In this description I explain the example of the present invention which is equipped to a bicycle for convenience. But the art of the present invention is not limited to a bicycle.

### BACKGROUND ART

Ordinarily, changing speed of bicycles is performed by derailleurs. The derailleur of common bicycles comprises two sets of gearing systems: one is front gearing system and the other is rear gearing system. The front gearing system includes a few or more front sprockets and a front gearing device, and the rear gearing system includes a few or more rear sprockets and a rear gearing device. A chain links one of the front sprockets to one of the rear sprockets. Selecting speed of a bicycle means that the chain selects one front sprocket among the front sprockets and one rear sprocket among the rear sprockets.

### DISCLOSURE OF INVENTION

### Technical Problem

To achieve an optimum speed condition while riding a bicycle, we have to adjust the front gearing system and the rear gearing system individually. It cause inconveniences. Although automatic transmission system is used, it is complex in structure and inefficient.

### Technical Solution

The first example of execution of the present invention is a simple and efficient automatic transmission system. And the second example of execution of the present invention is simple and efficient manual transmission system which allows speed changing with just one operation.

### ADVANTAGEOUS EFFECTS

The invention has the various effects in comparison to the past gear shifting system as follows.

Its first advantage is increased convenience for users. The first example of execution of the invention performs changing gears automatically according to the speed of a wheel without manual operation. The second example of execution of the invention allows this process with just one operation. In the past, riders had to operate the front gear shift and the rear gear shift individually for gear shift. Secondly, the rider's power is used most efficiently in the derailleur presented by the invention because the chain can transmit power between the front sprocket and the rear sprocket which rotate on the same plane of revolution. Thirdly, it has the weight reduction effect. The invention, especially the second example of execution, allows the manufacturer to produce lighter bicycle because the structure of the front gearing device and rear gearing device are very simple, and length of chain needed is shorter than that of past derailleurs. Fourthly, it is the reduction of troubles. While the chain transmits the power between large front sprocket and large rear sprocket in the existing derailleur, the abrasion between chain and sprockets is severe because the planes of revolution of the two sprockets are different. It is the same as well when the chain transmits power between small front sprocket and small rear sprocket.

### BRIEF DESCRIPTION OF THE DRAWINGS

FIG. 1 is a perspective view of first example of execution of the present invention.

FIG. 2 is a rough draft of first example of execution of the present invention showing cables' connection.

FIG. 3 is a perspective view of second example of execution of the present invention.

### BEST MODE FOR CARRYING OUT THE INVENTION

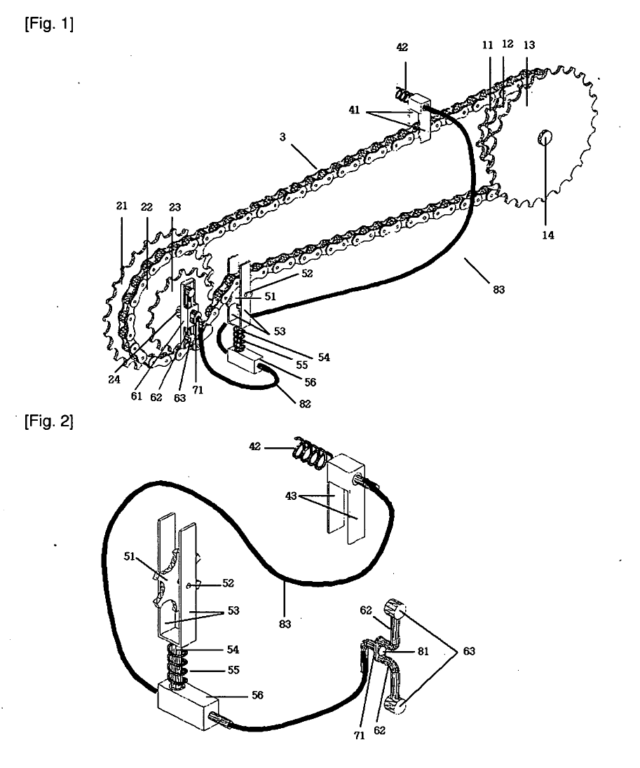

Hereinafter I explain the examples of execution of the invention. The following detailed description is an example of execution about the bicycle derailleur presented through the drawing of the invention. The example of execution presented in the FIG. 1 shows that bicycle derailleur consists of 3 front sprockets(11, 12, 13) which rotate on the pedal axis(14) and 3 rear sprockets(21, 22, 23) which rotate on the wheel axis(24). The 3 front sprockets are arranged with the pedal shaft as a rotation axis: a large front sprocket with many teeth and large diameter(13) at the very right side against moving direction, a medium front sprocket(12) in the middle, a small front sprocket(11) at the very left with equal interval. The 3 rear sprockets are also arranged with the wheel axis(24) as a rotation axis: a small rear sprocket with small diameter(23) at the very right side against moving direction, a medium rear sprocket(22) in the middle, a large rear sprocket(21) at the very left with equal interval as well. In the concrete, the large front sprocket(13) & the small rear sprocket(23) rotate on the same plane, the medium front sprocket(12) & the medium rear sprocket(22) rotate on the same plane, the small front sprocket(11) & the large rear sprocket(21) rotate on the same plane. For front sprocket and rear sprocket which rotate on the same plane and are connected with each other via the chain, they are called “corresponding sprocket” hereafter in this description.

A chain(3) transfers rotational power from the front sprockets to rear sprockets because the chain links one of the front sprockets to one of the rear sprockets. FIG. 1 shows that the chain(3) links the middle front sprocket(12) to the middle rear sprocket(22). The course on the plane of revolution is similar to a track on the playground. To be more specific, the course the chain follows has an indented part, because the guide sprocket(51) of the rear gearing device (51, 52, 53, 54, 55, 56) pushes the chain from the original course of the chain to the inside. It is for the close contact between the chain(3) & the front sprocket(12) and the chain(3) & the rear sprocket(22). Eventually, the length of the chain(3) is a little longer than the length of the track shape which surrounds front sprockets and rear sprockets, this excess length make the chain move to other front sprockets and rear sprockets with left and right movement. The chain(3) also passes through a front gearing device(41, 42) and a rear gearing device, the two gearing devices(5, 7) make the chain(3) move to the left and right so that the chain moves to adjacent front sprockets and rear sprockets. That is, when the chain(3) is positioned at the very left side against moving direction, it transmits rotational power from the small front sprocket(11) to large rear sprocket(21). When it is positioned at the center against moving direction, it transmits rotational power from the medium front sprocket(12) to medium rear sprocket(22). When it is positioned at the very right side against moving direction, it transmits rotational power from the large front sprocket(13) to the small rear sprocket(23). Power to move the chain(3) to the right and left side originates from a centrifugal device(61, 62, 63) rotating with the wheel shaft(24). While the centrifugal device is rotating with the wheel shaft(24), two weights generates centrifugal force. The centrifugal force is transmitted to the front gearing device(41, 42) and the rear gearing device(51, 52, 53, 54, 55, 56) through two weight cables(62), a combination device(71), a control cable(82) and a connection cable. Finally, the front gearing device(41, 42) and the rear gearing device(51, 52, 53, 54, 55, 56) move the chain(3) from originally engaged sprocket to the adjacent sprocket.

The front gearing device(41, 42) comprises a pair of legs(41) stretched out downward and a horizontal spring(42). The front gearing device(41, 42) is positioned at rear upper side of the front sprockets. The legs are installed to move only to the left and right and they are located in the position where the restitution force of the horizontal spring(42) and force from the connecting cable(83) are balanced. The gap between the legs(41) is a little wider than the width of the chain(3) and the chain pass through between the legs. While riding a bicycle, if the front gearing device move to the left and right, the chain(3) move from originally engaged sprocket to the adjacent sprockets.

A rear gearing device comprises a guide sprocket(51), a pair of arms(53), a vertical shaft(54), a vertical spring(55) and a body(56). Its a pair of arms (53) are stretched out upward. The gap between the arms is a little wider than the width of the chain(3) and the chain pass through between the arms. The guide sprocket(51) are linked to the arms with hinge joint(52). The guide sprocket(51) engages with the chain(3). The vertical shaft(54) is stretched out downward from the base of the arms. The vertical spring(55) surrounds the vertical shaft(54). It supports the vertical shaft, the arms and the guide sprocket(51) upwards. The body (56) has a vertical hole which is a bit bigger than the diameter of the vertical shaft (54) so vertical shaft can move up and down. Because of the upward support of this vertical spring(55), the guide sprocket(51) pushes the chain(3) upward, the tension in the chain can be maintained, and close contact between the chain & the front sprockets and the chain & rear sprockets can be maintained. The body(56) is linked to the control cable(82). The body(56) is installed to move only to the left and right against forward direction. If the control cable(64) is pulled, the rear gearing device is moved to the right. Finally the chain(3) is moved to the right. This movement of the chain(3) occurs in the front gearing system simultaneously because, when the control cable is pulled, the connection cable(83) linked with the control cable(82) is also pulled.

A centrifugal device comprises a housing(61), two weights(63) and two weight cables(62). The housing(61) revolves with the wheel shaft(24). There are two weights(63) and two weight cables(62) in the housing(61). The weights(63) can be moved to centrifugal or centripetal direction in the housing(61). There may be as many steps as the number of the rear sprockets in the pathway of the weights inside the housing. The weights(63) cannot be in boundary regions between steps. This makes sure the chain(3) is always placed in a proper sprocket. And the weight cables(62) links the weights(63) to the combination device(63). While the centrifugal device revolving with the wheel shaft(24), centrifugal force is generated by weights. This centrifugal force is transmitted to the combination device(71) by the weight cables(62)

The combination device(63) is an oval disk shaped with a hole admitting the control cable(64) in the center. The combination device(63) is installed to move only to the left and the right against forward direction. If the weights(63) are moved to centrifugal direction by rotation of the centrifugal device, the combination device(63) is moved to the left against forward direction.

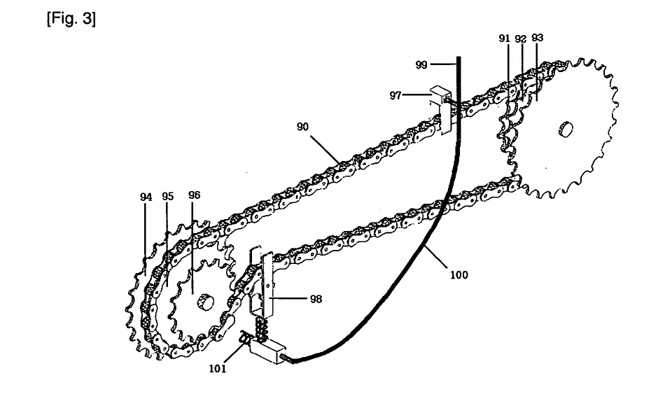

Hereinafter I explain the combination device(71), the control cable(82) and the connection cable(83) shown in FIG. 2. The control cable(82) is a cable which links the combination device(71) to the body(56) of the rear gearing device. The control cable(82) is freely rotable against the combination device(71) because the size of the hole diameter is larger than that of the cable diameter. And the control cable(82) cannot separable from the combination device(71) because the size of the head(81) of the control cable is larger than that of the hole of the combination device(71). The other end of the control cable(82) is linked to the body(56) of the rear gearing device.

The connection cable(83) is a string which links the body(56) of the rear gearing device to the legs(41) of the front gearing device.

Hereinafter I explain the operation process of the first example of execution of the present invention. While the wheel is very slowly rotating, the weights(63) are positioned at centripetal side because they generate so small amount of centrifugal force and restitution force of horizontal spring(42) pulls them through the connection cable(83), the body(56) the control cable(82), the combination device(71) and the weight cables(62). In this case a pair of legs(41) of the front gearing device and all part of rear gearing device(51, 52, 53, 54, 55, 56) are positioned in the left side against forward direction and the chain(3) engages with the small sprocket of the front sprockets and the large sprocket of the rear sprockets. In this case rotating velocity of the wheel shaft(24) is relatively slow in comparison to the pedal shaft(14). If rotating velocity of the wheel shaft(24) is increased, centrifugal force of the weights(63) is increased too. The amount of centrifugal force increases in proportion to square of angular velocity.

Centrifugal force generated in the weight(63) is transmitted to the horizontal spring(42) through the weight cables(62), the combination devices(71), the control cable(82), the body(56), the connection cable(83) and a pair of legs(42). Restitution force of the horizontal spring(42) increases in proportion to displacement of the legs(41) of the front gearing device. The legs(41) and all parts of rear gearing device are located at equilibrium position between centrifugal force of the weights(63) and restitution force of the horizontal spring(42). Consequently, the equilibrium positions are moved to the right side by increase of the angular velocity of the wheel shaft(24). If the angular velocity of the wheel shaft(24) decreases, reverse process of the above process is performed in this derailleur and the chain(3) is engaged with the left side adjacent sprocket.

### MODE FOR THE INVENTION

FIG. 3. shows the second example of execution of the present invention. The second example of execution is similar to the first example of execution. But, in the second example of execution, the origin of the force moving the chain is not centrifugal device but power of human. As the first example, 3 front sprockets(91, 92, 93) rotates with a pedal shaft and 3 rear sprockets(94, 95, 96) rotates with a wheel shaft. A chain(90) engages with one of the front sprockets and one of the rear sprockets. A front gearing device(97) is positioned at rear upper side of the front sprockets. A rear gearing device(98) is positioned at front lower side of the rear sprockets. A control cable(99) connect a controller(not shown here) to the front gearing device(97). A connection cable(100) connects the front gearing device(97) to the rear gearing device(98). There is no centrifugal device in the second example of execution. When a rider pull the control cable(99) through the controller(not shown here), the control cable(99) moves the front gearing device(97) to the right side and pull the connection cable(100) simultaneously. The connection cable(100) moves the rear gearing device(98) to the right side. Finally, the chain(90) is engaged with the right side adjacent sprockets. If the rider release the control cable(99), the reverse process is performed in this derailleur by restitution force of a horizontal spring(101).

The first example of execution is an example that the centrifugal force generated by 2 weights(63) move the front gearing device and the rear gearing device. The first example of execution and the second example of execution are examples that method moving the front gearing device and rear gearing device are cables. But there can be many other examples of execution. For example, they are examples of execution using external power sources (eg, motor) and electronic sensors sensing angular velocity of the wheel shaft instead of the centrifugal device and cables. The combination device of the first example of execution is a simple oval shaped disk. But its shape can be various and it may have an amplifier which amplifies force instead of reducing displacement of move: this amplifier may be a device using principle of lever. The first example of execution has one control cable(82). But other example of execution may have two control cables: one cable links the combination device(71) to the body(56) of the rear gearing device and the other cable links the combination device(71) to a pair of legs(41) of the front gearing device. In this case, a connection cable is not needed. In this case, the second cable is only a variant of connection cable because it plays the role of the connection cable of the example of execution of the present invention.

### INDUSTRIAL APPLICABILITY

The examples of execution of the present invention have 3 front sprockets and 3 rear sprockets. But the present invention is applicable to all derailleurs including 2 or more front sprockets and 2 or more rear sprockets. Only, it is advantageous that the number of front sprockets and the number of rear sprockets are equal and each corresponding sprockets rotate on same planes. If this kind of derailleur prevails, the existing complicated gear shift concept such as 18, 21, or 24 speeds will be gone, but the simple gear shift concept such as 2, 3, 4, or 5 speeds will come to stay. The present invention regards to a derailleur of bicycle. But the present invention can be apply to various fields of industry. For example, motor cycles, cars, or all kinds of machines requiring speed changing between principal axis and accompanying axis.

1. For a derailleur which includes 2 or more front sprockets and 2 or more rear sprockets, includes the chain that transmits power between the front sprockets and rear sprockets, includes the front gearing device and rear gearing device for moving the chain the left and right, a derailleur which has the same numbers of front sprockets and rear sprockets.

2. For a derailleur which includes 2 or more front sprockets and 2 or more rear sprockets, includes the chain that transmits power between the front sprockets and rear sprockets, includes the front gearing device and rear gearing device for moving the chain the left and right, a derailleur which comprises a centrifugal device rotating with the rear sprockets.

3. The derailleur as recited in claim 2, wherein the derailleur comprises a control cable connecting between the rear gearing device and the centrifugal device, in addition.

4. The derailleur as recited in claim 3, wherein the derailleur has the same numbers of front sprockets and rear sprockets.

5. The derailleur as recited in claim 1, wherein the derailleur comprises a mechanism which makes it possible to move the front gearing device and rear gearing device the same distance simultaneously.

6. The derailleur as recited in claim 5, wherein the mechanism comprise a cable that links the front gearing device and the rear gearing device.

7. The bicycle characterized by comprising the derailleur as recited in claim 1.

8-9. (canceled)

10. The derailleur as recited in claim 4, wherein the derailleur comprises a mechanism which makes it possible to move the front gearing device and rear gearing device the same distance simultaneously.
